(19) United States
(12) Patent Application Publication
(10) Pub. No.: US 2022/0183299 A1
(43) Pub. Date: Jun. 16, 2022

(54) Method for producing Cu-embedded plastic masterbatches

(71) Applicant: DAZZEON Technology Co.,Ltd., Taipei City (TW)

(72) Inventors: Thomas Chen, Taipei City (TW); Yi-Chung Wang, Taipei City (TW); Yong Chang, Taipei City (TW); Pei-Rong Shen, Taipei City (TW)

(21) Appl. No.: 17/058,358

(22) PCT Filed: Jul. 20, 2020
(86) PCT No.: PCT/CN2020/103099

§ 371 Date: Nov. 24, 2020

Related U.S. Application Data
(60) Provisional application No. 63/032,910, filed on Jun. 1, 2020.

(51) Int. Cl. A01N 59/20; A01P 1/00; A01P 3/00; A01N 25/04; A01N 25/30

(52) U.S. Cl. CPC A01N 59/20; A01P 1/00; A01N 25/30; A01N 25/04; A01P 3/00

(57) ABSTRACT

The invention relates to Cu-embedded masterbatches forming by a novel formulation and its production process. The novel formulation comprises a mixing powder prepared from Cu₂O and ZnO. The mixing powder is milled in water to form slurry. Spray-dry the slurry at 130˜150° C. to get anti-bacterial powder. Add 12 wt. %˜15 wt. % of the anti-bacterial powder to plastic masterbatches and follow by pre-mixing, heating, stirring, melting, extruding, cooling and cutting process to obtain the Cu-embedded masterbatches.

### TECHNICAL FIELD OF THE INVENTION

The present invention relates to a method for producing Cu embedded plastic masterbatches. In particular, the Cu embedded plastic masterbatches is a mixture containing a specific ratio of Cu₂O and ZnO. The Cu embedded plastic masterbatches is used to make antibacterial products that comprise face masks, clothes and bedding.

### BACKGROUND OF THE INVENTION

Fabric and non-woven fabric produced by traditional antibacterial plastic masterbatches are easy to be fragile, rough and decolorized. As a result, properties and performances of the final products are required to improve by additional processing, and this causes production cost increasing.

Based on the aforementioned description, an antibacterial material for producing fabric and non-woven fabric with good qualities are required for further developing.

### SUMMARY OF THE INVENTION

The invention provides a method for producing Cu embedded plastic masterbatches and its preparing formulation. Particularly, the Cu embedded plastic masterbatches apply to produce antibacterial fabric and/or non-woven fabric, such as face masks, clothes and bedding.

In one aspect, the preparing formulation comprises a composite powder comprises Cu₂O and ZnO. The composite powder has antibacterial function. Furthermore, the composite powder mixes with water, dispersing agents and antioxidants to form slurry. The dispersing agents comprise carboxylic acid copolymer, alkyl polyether, acidic polyether, poly(propylene glycol), poly(acrylic acid), polyacrylate, acidic polyester-polyamide, polyurethane, phosphate or their combinations. The antioxidant comprises phenolic compound, hexyl diamino compound, ester, alkyl carboxylic ester, propionyl ester, phosphate, phosphite, sulfite carboxylic ester or their combinations. The process includes milling the slurry to obtain fine particles in the slurry having an average diameter of 50˜1000 nm measured by DLS (Dynamic Light Scattering). Hence, surface area of the fine particles greatly increases. The fine particles have following benefits, such as enhancing mixing effect with plastic masterbatches, well dispersion, increasing antibacterial area, avoiding poor antibacterial effect and roughness of the final antibacterial products.

In another aspect, spray dry the aforementioned slurry containing the fine particles have an average diameter of 50˜1000 nm at 130˜150° C. to obtain an antibacterial powder. Add the antibacterial powder into plastic masterbatches. Preferably, 12˜15 wt. % of the antibacterial powder based on total weight of the plastic masterbatches is added into the plastic masterbatches, and the antibacterial powder comprises 1.5˜4 wt. % of Cu₂O and 8˜11 wt. % of ZnO. More addition amount of the antibacterial powder results in difficult processing, brittle fiber, poor mechanic properties and touching roughness of final fabric and/or non-woven fabric. Finally, perform following steps to obtain Cu-embedded plastic masterbatches. The following steps comprise pre-mixing step, heating and stirring step, melting-kneading step, extruding step, cooling step and granulating step.

In one aspect, the aforementioned Cu-embedded plastic masterbatches apply to fabricate antibacterial products that comprise face masks, clothes and bedding. The fabricating process includes melt blowing process, fiber spinning process and/or weaving process.

In one aspect, the plastic masterbatches comprise polyethylene, polypropylene, polyamide, PET, rayon fiber, Nylon or engineering plastic masterbatches obtaining from copper ammonia fiber.

In conclusion, the method for producing Cu embedded plastic masterbatches comprises following steps. (a) Mix Cu₂O powders and ZnO powders to form a composite powder. (b) Mix the composite powder with a dispersing agent and an antioxidant in water to form slurry. (c) Mill the slurry until to obtain fine particles in the slurry until the fine particles have an average diameter of 50˜1000 nm measured by DLS (Dynamic Light Scattering). (d) Spray dry the slurry at 130˜150° C. to obtain an antibacterial powder. (e) Add the antibacterial powder into plastic masterbatches. And (f) Perform following steps to obtain Cu-embedded plastic masterbatches, wherein the following steps comprise pre-mixing step, heating and stirring step, melting-kneading step, extruding step, cooling step and granulating step.

### BRIEF DESCRIPTION OF THE DRAWINGS

FIG. 1 is process flow diagram of the method for producing Cu-embedded plastic masterbatches;

FIG. 2 is particle size distribution of particles in the slurry at step (c);

FIG. 3 includes photos illustrating antibacterial performance of non-woven fabric made of the invented Cu-embedded PP masterbatches; and

FIG. 4 are quantitative plots illustrating antibacterial performance; FIG. 4(a) is a plot illustrating antibacterial performance of control group and FIG. 4(b) is a plot illustrating antibacterial performance of non-woven fabric made of the invented Cu-embedded PP masterbatches.

### BRIEF DESCRIPTION OF THE PREFERRED EMBODIMENTS

In a first embodiment, the present invention discloses a method for producing Cu-embedded plastic masterbatches. The method comprises following steps.

(a) Mix Cu₂O powders and ZnO powders to form a composite powder.

(b) Mix the composite powder with a dispersing agent and an antioxidant in water to form slurry.

(c) Mill the slurry.

(d) Spray dry the slurry at 130˜150° C. to obtain an antibacterial powder.

(e) Add the antibacterial powder into plastic masterbatches.

(f) Perform following steps to obtain Cu-embedded plastic masterbatches, wherein the following steps comprise pre-mixing step, heating and stirring step, melting-kneading step, extruding step, cooling step and granulating step.

In one embodiment, the dispersing agent comprises carboxylic acid copolymer, alkyl polyether, acidic polyether, poly(propylene glycol), poly(acrylic acid), polyacrylate, acidic polyester-polyamide, polyurethane, phosphate or their combinations.

In one embodiment, the antioxidant comprises phenolic compound, hexyl diamino compound, ester, alkyl carboxylic ester, propionyl ester, phosphate, phosphite, sulfite carboxylic ester or their combinations.

In one embodiment, the slurry consisting of 15˜20 wt. % of the composite powder, 5˜10 wt. % of the dispersing agent, 0.1˜0.5 wt. % of the antioxidant and 70˜75 wt % of water.

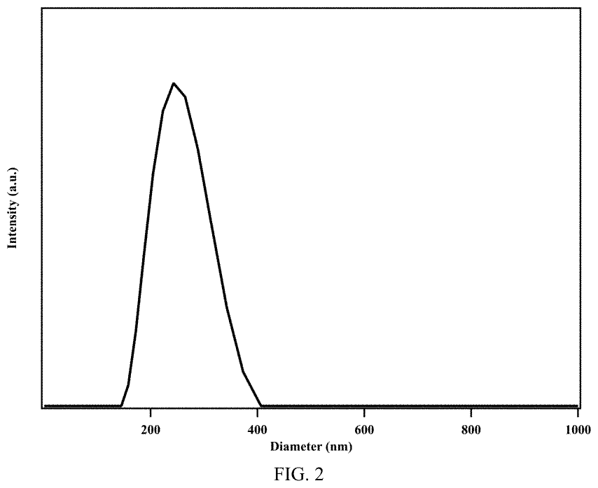

In one embodiment, the slurry at the step (c) comprises particles having an average diameter of 50˜1000 nm. Preferably, particles in the slurry at step (c) have an average diameter of 100˜500 nm measured by DLS (Dynamic Light Scattering) as shown in FIG. 2.

In one embodiment, 12˜15 wt. % of the antibacterial powder obtained from the step (d) based on total weight of the plastic masterbatches is added into the plastic masterbatches.

In one embodiment, the antibacterial powder comprises 1.5˜4 wt. % of Cu₂O and 8˜11 wt. % of ZnO.

In one embodiment, the plastic masterbatches comprise polyethylene, polypropylene, polyamide, PET, rayon fiber, Nylon or engineering plastic masterbatches obtaining from copper ammonia fiber.

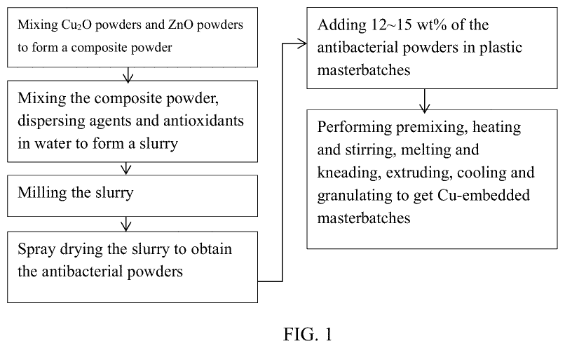

In one representative embodiment, the invention comprises steps as shown in FIG. 1. (a) Mix Cu₂O powders and ZnO powders to form composite powder; (b) mix 20 wt % of the composite powder, 5 wt % of the dispersing agent, 0.3˜0.5 wt % of antioxidant and about 75 wt % of water to form slurry. The dispersing agent is polypropylene glycol. The antioxidant is a composition consisting of 50 wt % of pentaerythritol tetrakis[3-[3,5-di-tert-butyl-4-hydroxyphenyl]propionate and 50 wt % of Tris(2,4-di-tert-butylphenyl)phosphite; (c) mill the slurry until particles in the slurry at step (c) have an average diameter of 50˜1000 nm. Preferably, particles in the slurry at step (c) have an average diameter of 100˜500 nm measured by DLS (Dynamic Light Scattering). (d) Spray dry the slurry at 130˜150° C. to obtain an antibacterial powder; (e) Add 12˜15 wt % of the antibacterial powder based on the plastic masterbatches into the plastic masterbatches; and (f) Perform following steps to obtain Cu-embedded plastic masterbatches, wherein the following steps comprise pre-mixing step, heating and stirring step, melting-kneading step, extruding step, cooling step and granulating step.

Working examples of the invention are described as following paragraphs.

### Example 1

Prepare Cu-embedded PP masterbatches (Cu-PP) according to following steps. (a) Mix 40 g of Cu₂O powders and 80 g of ZnO powders to form composite powder. (b) Mix 20 wt % of the composite powder, 5 wt % of the dispersing agent, 0.3˜0.5 wt % of antioxidant and about 75 wt % of water to form slurry with a stirrer (600˜1500 rpm). The dispersing agent is polypropylene glycol. The antioxidant is a composition consisting of 50 wt % of pentaerythritol tetrakis[3-[3,5-di-tert-butyl-4-hydroxyphenyl]propionate and 50 wt % of Tris(2,4-di-tert-butylphenyl)phosphite. (c) Mill the slurry by ball miller until particles in the slurry at step (c) have an average diameter of 50˜1000 nm. Preferably, particles in the slurry at step (c) have an average diameter of 100˜500 nm measured by DLS (Dynamic Light Scattering); (d) Spray dry the slurry at 130˜150° C. to obtain an antibacterial powder; (e) Add 12 wt % of the antibacterial powder based on polypropylene masterbatches into the polypropylene masterbatches; and (f) Perform following steps to obtain Cu-embedded PP masterbatches (Cu-PP). The following steps comprise pre-mixing step, heating and stirring step, melting-kneading step, extruding step, cooling step and granulating step.

### Example 2

Prepare Cu-embedded PET masterbatches (Cu-PET) according to following steps. (a) Mix 40 g of Cu₂O powders and 110 g of ZnO powders to form composite powder. (b) mix 20 wt % of the composite powder, 5 wt % of the dispersing agent, 0.3˜0.5 wt % of antioxidant and about 75 wt % of water to form slurry with a stirrer (600˜1500 rpm). The dispersing agent is polypropylene glycol. The antioxidant is a composition consisting of 50 wt % of pentaerythritol tetrakis[3-[3,5-di-tert-butyl-4-hydroxyphenyl]propionate and 50 wt % of Tris(2,4-di-tert-butylphenyl)phosphite. (c) Mill the slurry by ball miller until particles in the slurry at step (c) have an average diameter of 50˜1000 nm. Preferably, particles in the slurry at step (c) have an average diameter of 100˜500 nm measured by DLS (Dynamic Light Scattering). (d) Spray-dry the slurry at 130˜150° C. to obtain an antibacterial powder; (e) Add 15 wt % of the antibacterial powder based on PET masterbatches into the PET masterbatches; and (f) Perform following steps to obtain Cu-embedded PET masterbatches (Cu-PET), wherein the following steps comprise pre-mixing step, heating and stirring step, melting-kneading step, extruding step, cooling step and granulating step.

Evaluation of Antimicrobial Activity

The antimicrobial susceptibility of Cu-embedded textiles was evaluated by using Japanese Industrial Standard (JIS) L 1902: 2015. The estimation of living bacteria was following the pour plate method. Gram-negative bacteria Pseudomonas aeruginosa (ATCC 10145), Escherichia coli (ATCC 8739), Klebsiella pneumonia (ATCC 4352), and gram-positive bacteria Staphylococus aureus (ATCC 6538P), Methicillin resistant Staphylococcus aureus (MRSA, ATCC 33591), and fungi Candida albicans (ATCC 10231) were selected in this study. Briefly, a 1 ml of bacteria sample cultured in nutrient broth was placed on an agar plate. The plates were supplemented with Cu-embedded textiles and incubated at 37±1° C. for 18˜24 hours, and without textiles as controls. Concentrations of bacteria (CFU/ml) were counted before and after 18˜24 hours of culture at 37±1° C.

The antimicrobial susceptibility of Cu-embedded textiles after washing was executed in accordance with the procedures and standards of AATCC 135-2018, which was formulated by American Association of Textile Chemists and Colorists (AATCC). Textiles were washed at 30±3° C. and dried at less than 60° C., for 50 cycles. After laundering, antimicrobial activity tests were carried out.

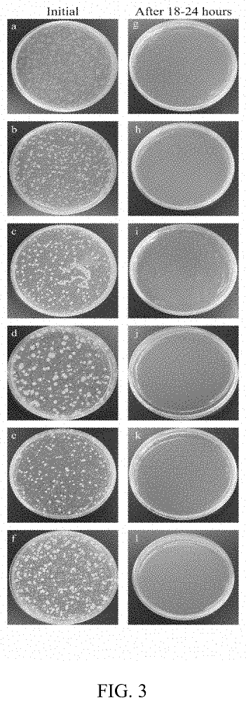

To evaluate the antimicrobial capability of Cu-PP fabric, examinations following Japanese Industrial Standard (JIS) L 1902: 2015 was employed. Here, five bacteria species inclusive of gram-positive and gram-negative ones and one fungi were selected (P. aeruginosa, E. coli, methicillin-resistant Staphylococcus aureus (MRSA), S. aureus, K. pneumoniae and C. albicans). FIG. 3 demonstrates the killing results. The left column is the number of bacteria of test pieces (approximately 3×10⁴ CFU/ml) immediately after inoculation of inoculum on Cu-PP fabric treated sample, and the right column corresponds to that after 18-24 hours of incubation. Apparently, the Cu-PP fabric shows a certain level of inhibition to bacteria growth. Less than 20 colony forming unit per milliliter (CFU/ml) of gram-positive, gram-negative bacteria, and fungi on agar plates were observed. Photo (a) and (g) are P. aeruginosa. Photo (b) and (h) are E. coli. Photo (c) and (i) are methicillin-resistant Staphylococcus aureus (MRSA). Photo (d) and (j) are S. aureus. Photo (e) and (k) are K. pneumoniae. (f) and (1) are C. albicans.

The antibacterial activity value (A) of fabrics defined by Japan Textile Evaluation Technology Council (JTETC) was further applied to evaluate the effectiveness of antibacterial property of a textile.

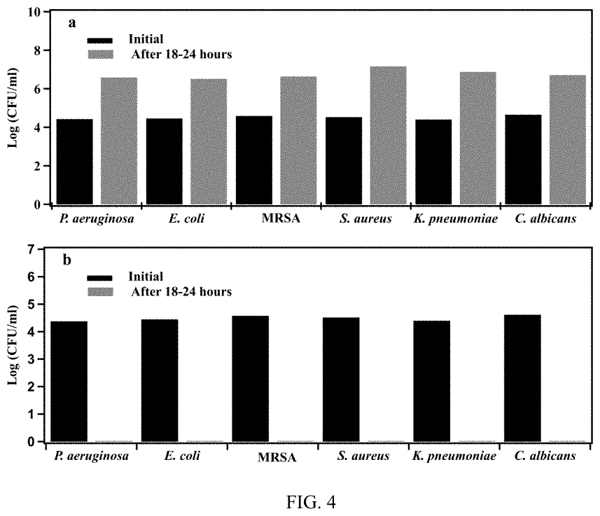

Accordingly, it is considered very effective against microorganisms if A is greater than 3. FIG. 4 compares the results of antimicrobial activity of controls and samples with the presence of Cu-PP non-woven textiles. The Cu-PP non-woven textile is very effective in inhibition of bacteria growth and bacteria killing.

Table 1 summarizes the antibacterial activity of all the selected species bacteria and fungi exposed to the Cu-PP fabrics, and all the activity values we have acquired are between 5 to 6. Apparently, there is no microbial selectivity of contact killing from the Cu-PP fabrics. In the present study, our results show that there is no distinct difference between effectiveness in eradicating gram-positive and gram-negative bacteria after 18-24 hours of surface contact.

Our approach that directly embeds Cu into plastic masterbatches can provide antimicrobial textiles with great washing resistance. TABLE 2 shows the antimicrobial activity of a Cu-PET fabric before and after 50 times of washes. It can be seen that the activity only decreased only by 3-6% upon bacteria species after 50 times of washes. The antimicrobial activity remains in the very effective category according to JIS L 1902: 2015.

Obviously, the Cu-embedded textiles made of the invented Cu-embedded plastic masterbatches possess excellent antimicrobial activities and washing resistance of antimicrobial activities.

TABLE 1

| | Antimicrobial |
|---|---|
| Bacteria species | activity(A) |
| P. aeruginosa (ATCC 10145) | 5.24 |
| E. coli (ATCC 8739) | 5.21 |
| MRSA (ATCC 33591) | 5.33 |
| K. pneumonia (ATCC 4352) | 5.57 |
| S. aureus (ATCC 6538P) | 5.86 |
| C. albicans (ATCC 10231) | 5.38 |

TABLE 2

| | Antimicrobial activity(A) | |
|---|---|---|
| Bacteria species | Before washes | After washes |
| P. aeruginosa (ATCC 10145) | 5.77 | 5.41 |
| E. coli (ATCC 8739) | 5.77 | 5.55 |
| MRSA (ATCC 33591) | 5.83 | 5.59 |
| K. pneumonia (ATCC 4352) | 5.86 | 5.55 |
| S. aureus (ATCC 6538P) | 5.62 | 5.42 |

In conclusion, the invention provides a method for producing Cu-embedded plastic masterbatches. The method comprises following steps. Step (a): mix Cu₂O and ZnO to form a composite powder. Step (b): mix the composite powder with a dispersing agent and an antioxidant in water to form slurry. Step (c): Mill the slurry. Step (d): Spray dry the slurry at 130˜150° C. to obtain an antibacterial powder. Step (e) Add 12˜15 wt. % of the antibacterial powder based on total weight of the plastic masterbatches into the plastic masterbatches. And step (f): Perform following steps to obtain Cu-embedded plastic masterbatches. The following steps comprise pre-mixing step, heating and stirring step, melting-kneading step, extruding step, cooling step and granulating step. In particular, particles in the slurry at the step (c) have an average diameter of 50˜1000 nm, and the antibacterial powder comprises 1.5˜4 wt. % of Cu₂O and 8˜11 wt. % of ZnO.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for producing Cu-embedded plastic masterbatches, comprising,
(a) mixing Cu₂O powders and ZnO powders to form a composite powder;
(b) mixing the composite powder with a dispersing agent and an antioxidant in water to form slurry;
(c) milling the slurry;
(d) spray-drying the slurry at 130˜150° C. to obtain an antibacterial powder
(e) adding the antibacterial powder into plastic masterbatches; and
(f) performing following steps to obtain Cu-embedded plastic masterbatches, wherein the following steps comprise pre-mixing step, heating and stirring step, melting-kneading step, extruding step, cooling step and granulating step.

2. The method for producing Cu-embedded plastic masterbatches of claim 1, wherein the dispersing agent comprises carboxylic acid copolymer, alkyl polyether, acidic polyether, poly(propylene glycol), poly(acrylic acid), polyacrylate, acidic polyester-polyamide, polyurethane, phosphate or their combinations.

3. The method for producing Cu-embedded plastic masterbatches of claim 1, wherein the antioxidant comprises phenolic compound, hexyl diamino compound, ester, alkyl carboxylic ester, propionyl ester, phosphate, phosphite, sulfite carboxylic ester or their combinations,

4. The method for producing Cu-embedded plastic masterbatches of claim 1, wherein the slurry consisting of 15˜20 wt. % of the composite powder, 5˜10 wt. % of the dispersing agent, 0.1˜0.5 wt. % of the antioxidant and 70˜75 wt % of water.

5. The method for producing Cu-embedded plastic masterbatches of claim 1, wherein the slurry at the step (c) comprises particles having an average diameter of 50˜1000 nm.

6. The method for producing Cu-embedded plastic masterbatches of claim 1, wherein 12˜15 wt. % of the antibacterial powder obtained from the step (d) based on total weight of the plastic masterbatches is added into the plastic masterbatches.

7. The method for producing Cu-embedded plastic masterbatches of claim 1, wherein the antibacterial powder at the step (d) comprises 1.5˜4 wt. % of Cu₂O and 8˜11 wt. % of ZnO.

8. The method for producing Cu-embedded plastic masterbatches of claim 1, wherein the plastic masterbatches comprise polyethylene, polypropylene, polyamide, PET, rayon fiber, Nylon or engineering plastic masterbatches obtaining from copper ammonia fiber.

9. A method for producing Cu-embedded plastic masterbatches, comprising the method of claims 1˜8.
